(19) United States
(12) Patent Application Publication
(10) Pub. No.: US 2024/0061452 A1
(43) Pub. Date: Feb. 22, 2024

(54) CONTROL AND OPERATION OF BRINE MAKING SYSTEM

(71) Applicant: THE TORO COMPANY, Bloomington, MN (US)

(72) Inventors: David Voigt, Le Center, MN (US); Derek N. Meyer, Saint Peter, MN (US)

(21) Appl. No.: 18/233,440

(22) Filed: Aug. 14, 2023

Related U.S. Application Data
(60) Provisional application No. 63/399,422, filed on Aug. 19, 2022.

(51) Int. Cl. G05D 11/13; G06Q 30/04

(52) U.S. Cl. CPC G05D 11/138; G06Q 30/04; E01H 10/00

(57) ABSTRACT

A method of operating a brine dispensing system of a brine making system includes connecting remotely to a controller of the brine making system with a control application. A brine transfer from brine storage of the brine making system to an external storage is initiated with the control application.

### CROSS-REFERENCE TO RELATED APPLICATION

This disclosure claims the benefit of the filing date of U.S. Provisional Patent Application No. 63/399,422, filed Aug. 19, 2022, which application is hereby incorporated by reference in its entirety.

### FIELD

The present disclosure relates to a brine making and dispensing system. More particularly, the present disclosure relates to a mobile application and method for managing jobs, tracking jobs, and adjusting brine making and dispensing parameters remotely and/or automatically.

### BACKGROUND

Pretreating surfaces with a brine solution prior to a pending snowstorm is an effective way to reduce problems with snow and ice accumulation on roadways and the like. When the application is timed correctly, the brine prevents snow and ice from sticking to the runways, roads, parking lots and walkways, which makes snow removal more efficient, both in time and cost. However, if the precipitation falls in the form of rain prior to snowing, the brine can be washed from the surface and rendered ineffective. Further, if the temperature drops below the freezing temperature of the brine prior to the snow falling, the brine is also rendered ineffective.

It has been found that the brine can also be applied after a snow, typically after the surface has been plowed or snow-blown. However, the post treatment with brine can be utilized without having prior snow removal. Post treating the surface with slightly more liquid deicing solution than used to pretreat the surface, such as 10 to 15% by volume, effectively removes snow and deices the surface without the need for pretreating. Using only post snow treatment eliminates the cost of pretreatment and the wear on equipment caused by the need for two passes per snow event.

It has been determined that brine works three to four times faster than rock salt and is more ecofriendly than rock salt. Because of the effectiveness of brine, less chlorides reach the storm water system. Further, the use of brine significantly lessens the damage to concrete and asphalt surfaces relative to rock salt. While not being bound to theory, it is believed that brine reduces the number of freeze/thaw cycles relative to rock salt that can be destructive to concrete and asphalt. As such, the use of brine as a pretreatment and after a snow event are beneficial to the surface being treated and the environment relative to the use of rock salt.

Since snow and ice events are unpredictable, and can occur at any time of the day or night, ready access to brine solutions is an important part of proper treatment of parking lots, roadways, sidewalks, and the like. Without 24/7 access to brine solutions, proper treatment may not be possible. Brine application methods would also benefit from the ability to provide brine solutions automatically from a brine making machine on an as-needed basis.

### SUMMARY

A method of operating a brine dispensing system of a brine making system includes connecting remotely to a controller of the brine making system with a control application. A brine transfer from brine storage of the brine making system to an external storage is initiated with the control application.

A non-transitory computer-readable storage medium includes instructions that cause a computer to connect remotely to a controller of a brine making system with a control application. The instructions further cause the computer to initiate a brine transfer from brine storage of the brine making system to an external storage with the control application.

A mobile application for controlling a brine dispensing system of a brine making system includes providing functionality to control functions of the brine dispensing system including connecting remotely to a controller of the brine making system with a control application. The mobile application further provides functionality for initiating a brine transfer from brine storage of the brine making system to an external storage with the control application.

### BRIEF DESCRIPTION OF THE DRAWINGS

FIG. 1 is a schematic diagram of a brine making and dispensing system according to an embodiment of the present disclosure;

FIG. 2 is a schematic diagram of a brine making and dispensing system according to another embodiment of the present disclosure;

FIG. 3 is a representative screen shot of manual operation and control of a brine making and dispensing system according to an embodiment of the present disclosure;

FIG. 4 is a representative screen shot of a brine monitoring operation function according to an embodiment of the present disclosure;

FIG. 5 is a representative screen shot of a brine making and control presentation and operation according to an embodiment of the present disclosure;

FIG. 6 is a representative screen shot of a brine dispensing and control presentation and operation according to an embodiment of the present disclosure;

FIG. 7 is a flow chart diagram of a method according to an embodiment of the present disclosure; and

FIG. 8 is a block diagram of a computer/controller on which embodiments of the present disclosure may be practiced.

### DETAILED DESCRIPTION

Embodiments of the present disclosure provide a program for control and operation of brine making systems, such as a system for mixing, preparing, and dispensing brine solutions for de-icing and/or snow removal. Embodiments of the present disclosure further provide a graphical user interface (GUI) and mobile application for control and operation of brine making systems, including preparation, dispensing, and billing/invoicing systems for brine making systems and dispensing of the brine. In embodiments described herein, the application/GUI is configured to interface with one or more controller units on a brine making and dispensing system to receive input from or output data to the program.

Embodiments of the disclosure provide a system that monitors the density change of a brine solution and wirelessly controls the operation of a brine making and dispensing system. In an exemplary embodiment, the system monitors conductivity of the brine which is correlated to density and/or salinity of the brine. The data regarding brine making, salinity, and dispensing is then sent to a controller, and then wireless provided to a device. The device contains an application or control program that allows a user to control operation of the brine making and dispensing system from the application/program. The embodiments also have the ability to wirelessly connect users who have been granted access to pay for solutions before they are dispensed and autonomously receive the solution without any further human interaction.

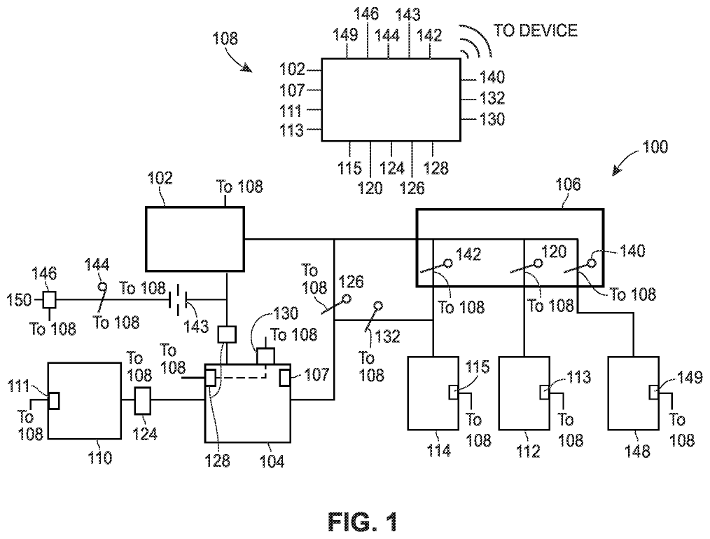

FIG. 1 illustrates a schematic for a brine making machine and system 100 on which embodiments of the present disclosure may be practiced. System 100 includes a pump 102, a mixing hopper 104, a manifold 106, and a controller 108. Controller 108 may be a separate component or may be incorporated into the pump, tank, manifold, or the like without departing from the scope of the disclosure. Mixing hopper 104 is in one embodiment a container in which ingredients for making brine are combined. Ingredients for making brine are supplied through various supply locations, including salt supply 110 and water supply 112. In one embodiment, the controller 108 controls operation of conveyers, augers, and/or gate valves that control the adding of salt from salt supply 110 and water from water supply 112 to the mixing hopper 104.

Valve 120 is used in one embodiment to control supply of water to the mixing hopper 104. Salt supply 110 provides salt to the mixing hopper 104 via some delivery system 124, such as a conveyer, auger, or a gravity feed supply that utilizes a gate type flow control mechanism. The conveyer, auger or gate mechanism may be motorized to provide salt to the mixing hopper 114 from the salt supply 110. Salt delivery system 124 may monitor the amount of salt supplied, or a separate salt supply amount control may be provided. However, such monitoring of the salt amount may not be necessary as sensors (described below) monitor the conductivity of a brine mixture in the mixing hopper 104, which can be correlated to density or salinity with the setpoint being saturation of dissolved salt in the water. Valve 120, salt delivery system 124, and pump 102 are electrically coupled to and operated and/or controlled in one embodiment by instructions or signals provided by controller 108.

Control of the valve 120 and salt delivery system 124 is in one embodiment effected by controller 108. Moving water from water supply 112 to mixing hopper 114 involves in one embodiment the use of the pump 102. Alternately, water under pressure may be supplied to the mixing hopper simply by opening the valve 120. As with the salt, an amount of water provided to the mixing hopper may be measured and apportioned using the valve 120, or a separate water supply amount control. As with the salt supply, the water supply may not need to be regulated specifically, as conductivity of the brine solution is measured, which can be correlated to salinity or density.

Once water and salt are added to the mixing hopper 104, the mixture is agitated by activating and opening an agitation valve 126 and activating the pump 102 to create flow and mix the water and salt to create brine. A conductivity sensor 128 monitors conductivity of the brine solution, which is then correlated to density or salinity. An external read out 130 is provided in one embodiment to provide information about the conductivity, salinity and/or density of the brine. The conductivity sensor 128, agitation valve 126, and pump 102 are electrically coupled to and operated and/or monitored in one embodiment by controller 108. The conductivity sensor 128 can be located in the mixing hopper 104 or the in the mixing line.

When agitation valve 126 is activated, pump out valve 132 to brine storage 114 is closed. When brine is at its desired conductivity which is correlated to salinity, such as saturation of dissolved salt in the water, agitation valve 126 is closed. Transfer of the brine solution to a brine storage 114 may be affected by opening valve 132 and pumping brine to brine storage 114 with pump 102. Valve 132, and as mentioned, pump 102, are in one embodiment electrically coupled to and operated and/or controlled by controller 108. Brine solution is pumped from mixing hopper 104 to brine storage 114. From brine storage 114, brine may be supplied to manifold 106 by operating pump 102 and brine valve 142 to pump brine from brine storage 114 to manifold 106. From manifold 106, brine may be pumped out to an external tank by operation of pump 102 and valve 144.

Valve 144 is operated to provide output of manifold contents to outlet 150. Pump 146 may be used in one embodiment to provide flow through manifold 106 to the outlet 150. Flow meter 143 senses a volumetric flow rate and sends a signal to the controller 108 and an optional digital readout 146. The flow meter 143 provides the amount of brine that is dispensed to a customer and also allows for mixing of certain ratios of, for example, brine solution to an additive that can further suppress the freezing point of the brine, or the like. Valve 144 and flow meter 143 are in one embodiment electrically coupled to and monitored and/or controlled by controller 108. When it is desired to add additive to the output 150, valve 140 is opened between additive supply 148 and manifold 106, while brine valve 142 is closed. Pump 102 pumps additive through to the output 150, while agitation valve 126 and pump put valve 132 are closed to isolate the mixing hopper 104 from the rest of the system 100. Ratios of additive versus brine may be selected to account for specific road conditions or the like. More than one brine solution may also be used in some embodiment, such as part salt brine, part calcium chloride brine. Additives may include, but are not limited to, organic compounds such as by-products from cheese whey, sugar beets, or other organic ingredients. Once brine in brine storage 110 is at its desired salinity, mixing of brine solution with additives may be done by volume.

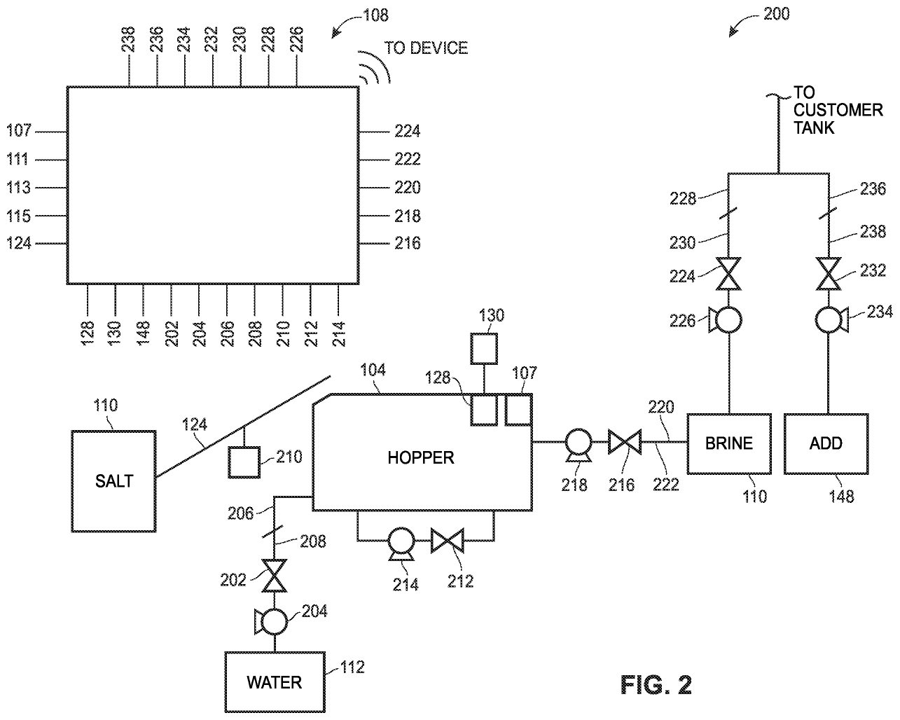

Manifold 106 in one embodiment includes inputs of water from water supply 112, brine solution from brine storage 136, and a brine solution additive from additive tank 148. Manifold 106 (see also FIG. 2) can provide water, brine, additive, or a combination of one or more of brine, additive, and water to output 150. Valves 120 between water supply 112 and manifold 106, 140 between additive supply 148 and manifold 106, and 142 between brine storage 114 and manifold 106 are electrically coupled to and operated and/or controlled by controller 108.

Storage and supply tanks 110 for salt, 112 for water, 114 for brine, and 148 for additive include in one embodiment respective level sensors 111, 113, 115, and 149 that detect level of product in their respective tanks. The sensors 111, 113, 115, and 149 are electrically coupled to controller 108 to provide sensor data to the controller 108.

In some embodiments, the controller 108 monitors the levels in the tanks 110, 112, 114 and 148 with the respective sensors 111, 113, 115 and 149. In some embodiments, the controller 108 causes the tanks, 110, 112 and 114 to be filled once a low-level set point is reached. For instance, water is added to the tank 112 and additives are added to tank 114 to ensure the necessary supplies are maintained for the anticipated demand. When the brine tank 110 reaches a low-level set point, water and salt are added to the mixing hopper 104 to make brine. Once the brine is at a selected conductivity, the brine is then transferred to the tank 110 such that a required amount of brine at the selected conductivity is stored in the tank 110.

FIG. 2 is a schematic view of another embodiment of a brine making system 200 on which embodiments of the present disclosure may be practiced. Elements of system 200 that are the same as elements of system 100 have the same numbers, and unless otherwise described, function in the same way and for the same purpose as those in system 200.

Brine making system 200 comprises, in one embodiment, a mixing hopper 104 and a controller 108. Controller 108 may be a separate component or may be incorporated into the system as a part of mixing hopper 104 or the like without departing from the scope of the disclosure. Mixing hopper 104 is in one embodiment a container in which ingredients for making brine are combined. Ingredients for making brine are supplied through various supply locations, including salt supply 110 and water supply 112. In one embodiment, the controller 108 controls operation of conveyers, augers, and/or valves that control the adding of salt from salt supply 110, and a valve or pressure system to provide water from water supply 112 to the mixing hopper 104.

Valve 202 is used in one embodiment to control supply of water from water supply 112 to the mixing hopper 104. Pump 204 is operable to pump water from water supply 112 to mixing hopper 104. When valve 202 is opened, and pump 204 is engaged, water may be pumped to mixing hopper 104. A flow meter 206 is provided in one embodiment to monitor an amount of water provided to the mixing hopper 104. Air purge 208 may be used to empty the water line between valve 202 and mixing hopper 104. In one embodiment, one or more of valve 202, pump 204, meter 206, and air purge 208 are electrically coupled to and operated and/or controlled by instructions or signals provided by controller 108. The water supply may not need to be regulated specifically, as salinity of the brine solution is measured. A tank level sensor 107 is used in one embodiment to monitor a level of the mixing hopper 104

Salt supply 110 provides salt to the mixing hopper 104 via some delivery system 124, such as a conveyer, auger, or a gravity feed supply. The conveyer/auger may be motorized to provide salt to the mixing hopper 114 from the salt supply 110. Salt delivery system 124 may monitor the amount of salt supplied with meter 210, or a separate salt supply amount control may be provided. However, such monitoring of the salt amount may not be necessary as sensors (described below) monitor the salinity of a brine mixture in the mixing hopper 104. In one embodiment, salt delivery system 124 and meter 210 are electrically coupled to and operated and/or controlled by instructions or signals provided by controller 108.

As with the water, an amount of salt provided to the mixing hopper may be measured and apportioned using the salt delivery system 124, or a separate salt meter 210. As with the water supply, the salt supply may not need to be regulated specifically, as conductivity of the brine solution is measured.

Once water and salt are added to the mixing hopper 104, an agitation is performed by opening agitation valve 212 and engaging pump 214 to create flow and mix the water and salt to create brine. A conductivity sensor 128 monitors conductivity of the brine solution, which can be correlated to salinity and/or density of the brine. An external read out 130 can optionally be provided in one embodiment to allow an operator to monitor the brine making process. The conductivity sensor 128, agitation valve 212, and pump 214 are electrically coupled to and operated and/or monitored in one embodiment by controller 108.

When agitation valve 212 is active, pump out valve 216 and pump 218 to brine storage 114 are closed. When brine is at its desired conductivity that correlates to density or salinity, such as saturation, agitation valve 212 is closed and pump 214 is turned off. Transfer of the brine solution to a brine storage 114 may be affected by opening valve 216 and pumping brine to brine storage 114 with pump 218. A meter 220 is provided in one embodiment to monitor an amount of brine pumped to brine storage 110. Air purge 222 may be used to empty the line between valve 216 and brine storage 110. In one embodiment, one or more of valve 216, pump 218, meter 220, and air purge 222 are electrically coupled to and operated and/or controlled by instructions or signals provided by controller 108.

From brine storage 114, brine may be supplied to a customer tank (not shown) by opening valve 224, and starting pump 226. Brine is pumped from brine storage 110 to the customer tank. A meter 228 is used in one embodiment to monitor the amount of brine transferred to the customer tank. Air purge 230 is provided to clear the brine line between valve 224 and the customer tank. In one embodiment, one or more of valve 224, pump 226, meter 228, and air purge 239 are electrically coupled to and operated and/or controlled by instructions or signals provided by controller 108.

If additives are to be added to the brine solution, valve 232 is opened, and pump 234 turned on to pump additive from additive storage 148 to the customer tank. A meter 236 is used in one embodiment to monitor the amount of additive transferred to the customer tank. An exemplary additive is a freezing point suppressant, such as an aqueous mixture of calcium chloride Air purge 238 is provided to clear the additive line between valve 232 and the customer tank. In one embodiment, one or more of valve 232, pump 234, meter 2360, and air purge 238 are electrically coupled to and operated and/or controlled by instructions or signals provided by controller 108.

In one embodiment, the controller 108 receives information from a user about a desired mixture of brine and additive or a desired freezing point of the solution, and controls operation of the pumps and valves 226/234 and 224/232 and uses meters 228/236 to monitor mixing of certain ratios of, for example, brine solution to additive, or the like.

Storage and supply tanks 110 for salt, 112 for water, 114 for brine, and 148 for additive include in one embodiment respective level sensors 111, 113, 115, and 149 that detect a level of product in their respective tanks. The sensors 111, 113, 115, and 149 are electrically coupled to controller 108 to provide sensor data to the controller 108.

In each of systems 100 and 200, supply levels for salt, water, brine, and additive may be monitored, and an alert may be made for low levels of any supply, or produced brine solution. For example, if brine solution drops below a certain level, an automatic brine making operation of the mixing tank 104 may be initiated by controller 108.

Functions of the brine system 100 or 200 are automated for control by controller 108 operating under instructions provided externally in one embodiment. Controller 108 is communicatively coupled, via a wired or wireless connection, to a program or application for automated making of brine, sensing of conductivity that can be correlated to saturation/salinity/density, and/or dispensing of brine from system 100/200.

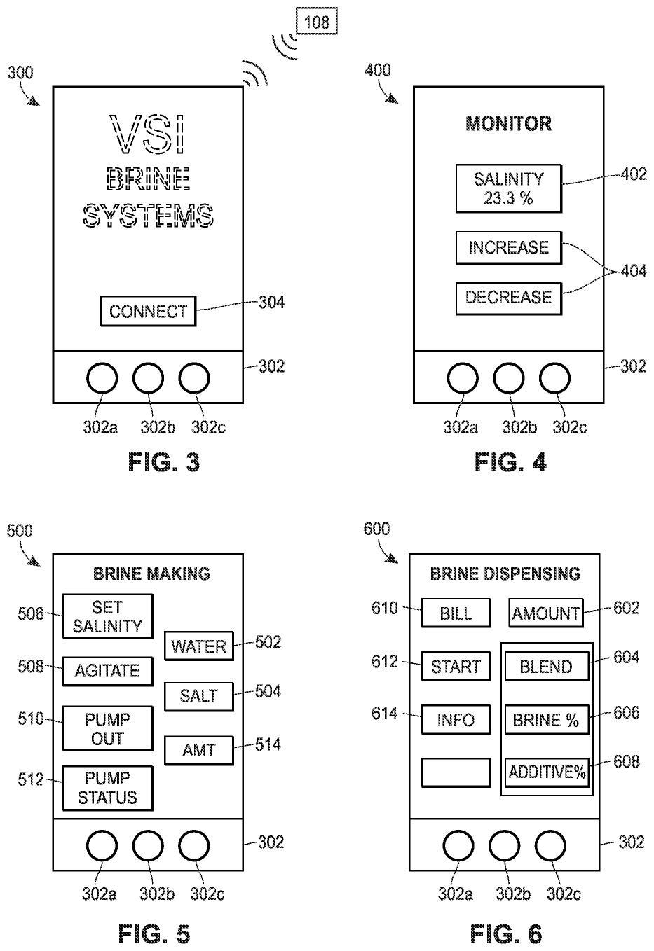

FIG. 3 illustrates a display with a representative graphical user interface (GUI) screen 300 of a control application for a brine making and dispensing system. While the GUI screen 300 is shown as a mobile phone screen, it should be understood that the screen may be that of a tablet, a laptop, or other computer without departing from the scope of the disclosure. Screen 300 includes an information section 302 for display of information regarding the operation and control of the brine making and dispensing system. This may be gathered in one embodiment by connecting to the controller 108 of a system 100/200, such as by wireless connection (e.g., cellular transmission, radio frequency (RF), WiFi, Bluetooth®, etc.) Information section 302 includes in one embodiment displays showing monitor brine 302a, make brine 302b, and dispense brine 302c. A connect button 304 allows connection of a user to the brine making and dispensing system, such as with a known user identification (user ID) and password, which may be linked to an account or the like, including user information, billing particulars, and the like.

Connection of a tool, such as but not limited to a mobile application capable of operation on a computer, mobile phone, tablet, mobile computer, or the like, to a brine making and dispensing system allows control thereof without an operator being subjected to harsh conditions, and fully automates the process of preparation and dispensing of brine solution, even if the brine making system is not manned by an operator. In one embodiment, connection of the brine making and dispensing system controller to the control tool (e.g., mobile application) is by wireless connection, for example, cellular transmission, RF, WiFi, Bluetooth®, etc. In one embodiment, a brine making and dispensing system is controlled by the application, and allows a user to control a number of brine making and dispensing system functions. For example, a user can initiate and monitor functions including:

Reading and converting information from a conductivity measuring device Full control of motor/pump start stop

Automatic operation of solution pump out and fresh water fill

Automatic loading of salt (or desired product to be mixed)

Storage tank level monitoring

Pumping finished solution from the machine or storage tanks into sprayers or other storage vessels

Recording production rates

Volume tracking of product made/pumped out with time stamps and graph displays

Product blending (two or more products blended together to obtain a set volume or physical characteristic of the brine) (This is performed by inputting a set volume where each product to be added is a percentage of total volume where concentrations of each stream are known. The products being blended are monitored with a flow meter and controlled by electric valves).

Ability for other users to “log in” to the machine, select the quantity of brine or other material that they desire, and have the system 100/200 fill their sprayer or other storage vessel. The user ID is then recorded for future billing. It should be noted that the user ID could also be linked to a credit card or debit account for collection of payment before the product is dispensed, such as like a fueling station, electric charging station, or the like.

Control Air purge at specific times in the pump out process

Transmit all information wirelessly. Examples include but are not limited to cellular transmission, RF, WiFi, Bluetooth®, etc.

Use and operation of the brine making and dispensing system with the control tool (such as the program showing the GUI screens) is described in further detail below. Once a user is connected, having used a connection button such as 304, options for operation of the system appear on the GUI. Options include main menus and sub-menus.

In one embodiment, selection of monitor brine button 302a in section 302 brings up a monitoring screen 400 as illustrated in FIG. 4

The system 100/200 includes the controller 108 for receiving data from the sensors described above, and for calculating conversions. A conductivity sensor is used to read the density change of the solution. It should be noted that a conductivity sensor is not the only manner of measuring the density change of a solution. Any device which can measure conductivity, density or salinity directly would be applicable in this application. The sensor is mounted inline with the plumbing in one embodiment, but could be mounted in any location where it is in contact with the brine solution. The controller then transmits the information to a receiving device such as a device operating the control application. Any form of wireless transmission could be utilized as well as any device capable of receiving wireless information. The user then monitors the conductivity or correlated density of the solution on the application or platform on the device, as shown in FIG. 4. The controller determines and provides to the device a constant reading of the conductivity/current density/saturation level of the brine solution. The user is then notified when the solution has reached the desired saturation level. Additional controls such as controls 404 to increase or decrease the salinity are provided in GUI screen 400. To aid the user in assessing a desired saturation level, the system 100/200 of the present disclosure can receive, preferably wirelessly, real-time or near-real-time data, including one or more of current area weather information, forecasted weather conditions, road conditions, traffic reports, snow accumulation, ambient temperature, humidity, and condition of brine application equipment, to automatically determine a recommended saturation level. Such data could also be used to inform recommendations in product blends used to achieve a particular volume or characteristic, such as concentration, of the brine to be produced. This recommended saturation level and/or product blend could be displayed to the user via the graphical user interface to inform the user's decision as to what concentration and/or product blend to input when providing instructions to the system. Instead or in addition, the data could be used to automatically instruct the controller as to the appropriate target saturation level, in a closed loop fashion, such that brine with optimal saturation level for current (or predicted) conditions is produced without the necessity for user input. Also, instead or in addition, the data regarding the condition of the brine application equipment can include volume of brine solution remaining in one or more storage tanks of a brine application vehicle, or even volume and concentration of brine solution remaining in one or more storage tanks of a brine application vehicle, and the communication of such remaining volume or remaining volume and concentration data can be used to determine the volume or the volume and concentration of brine to be delivered to such storage tanks by the system 100/200.

It should be further noted that while the sensors and controller as shown in FIGS. 1 and 4 are used in one embodiment to monitor the conductivity which is correlated to salinity of brine in a brine making machine, conductivity is not the only measurement that could be read. For example only, many other additives can be made including but not limited to calcium chloride, magnesium chloride, inhibitors, or anything that requires mixing a water soluble solution and therefore changing the density of the solution. In one embodiment, the sensor 128 is for measuring and monitoring the percent saturation by weight of a salt brine solution. The data is measured, and converted to percent saturation and then sent wirelessly to the remote device by the controller and displayed at 402,

FIG. 5 illustrates a GUI screen 500 for making brine as selected by selection option 302b of information section 302 (FIG. 3). Options for brine making include introduce water at 502, introduce salt at 504, set salinity at 506, agitate at 508, pump out at 510, and pump status at 512. In some instances, making of brine at the system 100/200 is manually set with the GUI screen 500, and information on what brine is to be made is sent to controller 108.

In order to make brine in such an automated fashion, the valves and sensors of the system 100/200 are controlled by the controller 108 under direction of a user operating the GUI. In one embodiment, a user indicates how much brine is desired to be made at 514, and the system operates automatically at this instruction to make brine.

The system 100/200 also is capable of controlling functions on the solution making system, for example, continuous solution making where the controller 108 can operate valves to pump out/fill the machine, turn the motor/pump on or off, record gallons made and track gallons leaving storage tanks, such as is described further below.

Making brine automatically includes operating the valves and controlling the agitating and pump out functions of the system 100/200. In one embodiment, when an instruction to make brine at a certain salinity is received at the controller, a check is made to see if the amount of brine available is sufficient to provide the desired volume of brine. If not, the controller 108 activates salt delivery system 124 to add a measured amount of salt from salt supply 110 to mixing hopper 104. Water is added automatically by opening valve 120 and starting pump 102 to provide water to the mixing hopper 104 for system 100, and by opening valve 202 and starting pump 204 in system 200. When sufficient water and salt are added, valves 120/202 are closed and pumps 204 shut off, salt delivery system 124 is deactivated, and agitation begins by opening valve 126/212 and starting pump 102/214 to create flow and agitate the mixture in the mixing hopper 104. The salinity sensor 128 monitors salinity in the mixing hopper until the desired salinity is reached. At this point, the agitate valve 126/212 is closed and pump 214 shut off, and pump out valve 132/216 is opened to pump the manufactured brine solution from the mixing hopper 104 to the brine storage tank 114.

This process may be repeated as necessary, and may be started by users through the GUI of the control application, all without an operator being physically present. When brine is available, the GUI may present information to a user about the amount available, as determined by level sensor 115 or the like, and that brine is available for dispensing.

Dispensing brine automatically may be accomplished using the control application, and selecting brine dispensing control 302c of section 302. A representative brine dispensing GUI screen 600 is illustrated in FIG. 6. When brine dispensing is desired, and GUI screen 600 is brought up, buttons and information provided by controller are available, including for example only, amount 602, blend control 604 with brine % 606 and additive % 608, billing button 610, start button 612, and information button 614. When a user arrives at the location of the system 100/200, the user can physically connect a hose such as a filler hose to output 150 of the brine making and dispensing system 100 or customer tank of the brine making and dispensing system 200, and use the controls of the control application to pay for and dispense brine to the users tank/vehicle mounted system, or the like.

In operation, when brine is to be dispensed from the system 100, the agitation valve 126 and pump out valve 132 are closed to isolate the mixing hopper from the dispensing. Valve 142 is opened and pump 102 started to pump brine solution from the brine storage tank to output 150. In one embodiment, valve 144 remains closed until it is confirmed that a filler hose is attached to output 150. Sensor and display 146 allows a user to physically verify an amount of product that has been dispensed. This information is also available in the control application.

In operation, when brine is to be dispensed from the system 200, pump out valve 224 is opened and pump 226 is started to pump brine solution from the brine storage tank to the customer tank.

If additive is also to be added to the brine solution, the blend option 604 may be selected, and a percentage of brine versus percentage of additive may be entered. Once brine solution in the proper amount is dispensed, valve 142/224 is closed, and valve 140/232 is opened and pump 102/234 started to pump additive to output 150/customer tank.

Once the amount of brine and additive to be dispensed is determined, a billing may be affected, either at the site, through saved billing information, or the like.

Embodiments of the present disclosure provide an automated system for remotely monitoring salinity of a brine solution, for making and storing brine solution, and for dispensing and billing for brine solution, all in a way controlled by a controller along with sensors and valves within the brine making system, and operated remotely using a GUI of a control application.

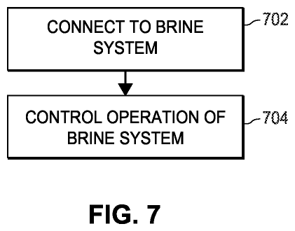

In one embodiment, a method 700 for operation and workflow management of a brine maker such as system 100/200 is shown in flow chart form in FIG. 7. Method 700 comprises connecting with a brine making and dispensing system in block 702, and controlling operation thereof, including monitoring salinity of the brine solution, making brine solution to order, and dispensing brine solution in block 704. Further, operation and workflow management include system start-up, monitoring, setting levels of water and salt, agitating, pumping to storage, dispensing, blending additive with brine, billing, and the like, all through a control application that functions to operate the system by transmitting information on operation wirelessly to a controller of the system.

All details of brine making, dispensing, and billing are maintained in the controller, such as in a memory thereof, and are available for retrieval by the control application. Further, reports on any particular job, event, or the like may be generated from identified jobs and the like.

Dispensing in one embodiment is along the lines of a fully accessible brine station, available at all times. The system may include a physical card reader for payment at the brine station, like a pay at the pump gas station, but for brine solution. As applications of brine are not necessarily scheduled events, and on-demand solution such as that provided by the embodiments of the present disclosure allows customers access to an autonomous brine fill and blend products with no need for human interaction. It is an uninterrupted, 24/7 fill station, paired to an automated machine that makes the solution.

Further, while brine solutions are described herein, the brine making and dispensing system of the present disclosure can be used with any liquid and for purposes besides melting snow and ice and/or pretreating a surface. It is within the scope of the present disclosure that a solution without chloride ions could be made to pretreat surfaces prior to a snowfall or to remove snow and ice after a snowfall.

The control application discussed herein has been described in terms of an application on a mobile telephone, tablet computer, or the like. In another embodiment, control of a brine making and dispensing system such as those described herein, as well as the control functions and operation described herein, may be implemented in a different form, such as a remote control operating on, for example, a radio frequency (RF) band of operation. Such a remote control has the functions and capabilities of the application embodied therein, and may include, for example, selection buttons, a keypad, number pad, touch screen, display, or the like. Other remote controls operating on other frequencies are also within the scope of the disclosure.

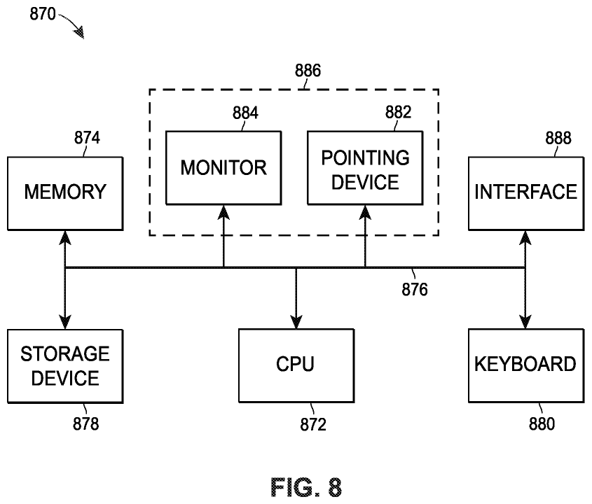

FIG. 8 and the related discussion provide a brief, general description of a suitable computing environment in which the controller can be implemented. Although not required, the controller can be implemented at least in part, in the general context of computer-executable instructions stored on a non-transitory computer readable medium, such as program modules, being executed by a computer 870 which may be connected in wired or wireless fashion to the controller. Generally, program modules include routine programs, objects, components, data structures, etc., which perform particular tasks or implement particular abstract data types. Those skilled in the art can implement the description herein as computer-executable instructions storable on a computer readable medium. Moreover, those skilled in the art will appreciate that the embodiments of the disclosure may be practiced with other computer system configurations, including mobile computers, tablet computers, cellular telephones, mobile telephones, multi-processor systems, networked personal computers, mini computers, main frame computers, and the like. Aspects of the disclosure may also be practiced in distributed computing environments where tasks are performed by remote processing devices that are linked through a communications network. In a distributed computer environment, program modules may be located in both local and remote memory storage devices.

The computer 870 comprises a conventional computer having a central processing unit (CPU) 872, memory 874 and a system bus 876, which couples various system components, including memory 874 to the CPU 872. The system bus 876 may be any of several types of bus structures including a memory bus or a memory controller, a peripheral bus, and a local bus using any of a variety of bus architectures. The memory 874 includes read only memory (ROM) and random access memory (RAM). A basic input/output (BIOS) containing the basic routine that helps to transfer information between elements within the computer 870, such as during start-up, is stored in ROM. Storage devices 878, such as a hard disk, a floppy disk drive, an optical disk drive, etc., are coupled to the system bus 876 and are used for storage of programs and data. It should be appreciated by those skilled in the art that other types of non-transitory computer readable media that are accessible by a computer, such as magnetic cassettes, flash memory cards, digital video disks, random access memories, read only memories, and the like, may also be used as storage devices. Commonly, programs are loaded into memory 874 from at least one of the storage devices 878 with or without accompanying data.

Input devices such as a keyboard 880 and/or pointing device (e.g. mouse, joystick(s)) 882, touch screen, microphone for voice control, virtual controller such as a virtual reality (VR) set or an augmented reality (AR) set, or the like, allow the user to provide commands to the computer 870. A monitor 884 or other type of output device can be further connected to the system bus 876 via a suitable interface and can provide feedback to the user. If the monitor 884 is a touch screen, the pointing device 882 can be incorporated therewith. The monitor 884 and input pointing device 882 such as mouse together with corresponding software drivers can form a graphical user interface (GUI) 886 for computer 870. Interfaces 888 on the computer 870 allow communication to other computer systems such as via the peer-to-peer embodiments discussed above.

Although the present disclosure has been described with reference to preferred embodiments, workers skilled in the art will recognize that changes may be made in form and detail without departing from the spirit and scope of the disclosure.

What is claimed is:

1. A method of operating a brine dispensing system of a brine making system, comprising:
connecting remotely to a controller of the brine making system with a control application; and
initiating a brine transfer from brine storage of the brine making system to an external storage with the control application.

2. The method of claim 1, and further comprising monitoring a level of available brine in the brine storage with the control application.

3. The method of claim 1, wherein initiating a brine transfer comprises isolating a mixing hopper of the brine making system with the control application, opening a brine valve of the brine making system with the control application, and activating a pump of the brine making system with the control application.

4. The method of claim 3, and further comprising setting an amount of brine to transfer with the control application.

5. The method of claim 4, and further comprising selecting a percentage of brine versus brine additive to be transferred by controlling the brine making system with the control application.

6. The method of claim 5, wherein selecting a percentage of brine and selecting a percentage of brine additive is done using a graphical user interface on the control application.

7. The method of claim 6, and further comprising directing a blend of brine and brine additive with a flow control selection on the control application.

8. The method of claim 7, wherein directing a blend comprises selecting a total volume of material to be transferred from the brine making machine, and selecting a percentage level of volume of each of brine and brine additive.

9. The method of claim 1, wherein the control application is used to log in to the controller for billing for brine transferred to the external storage.

10. The method of claim 1, wherein initiating the brine transfer comprises:
entering a unique log in via the control application;
providing billing information for a brine dispensing operation via the control application; and
controlling dispensing of brine form the brine dispensing system via the control application, including controlling a volume of brine dispensed and an optional volume of brine additive dispensed.

11. The method of claim 1, and further comprising:
checking with the control application whether a user determined volume of brine is available for transfer to the external storage;
in the event there is a sufficient volume of brine available for transfer of the user determined volume to the external storage, transferring the user determined volume of brine to the external storage; and
in the event there is not a sufficient volume of brine available for transfer of the user determined volume, initiating brine making with the control application.

12. The method of claim 1, wherein connecting to the controller is accomplished via Bluetooth®, WiFi, radio frequency, or cellular transmission.

13. The method of claim 1, wherein when a brine level drops below a predetermined level, a brine making operation is initiated.

14. A non-transitory computer-readable storage medium including instructions that cause a computer to:
connect remotely to a controller of a brine making system with a control application; and
initiate a brine transfer from brine storage of the brine making system to an external storage with the control application.

15. The non-transitory computer-readable storage medium of claim 14, wherein the instructions further cause the computer to cause the controller to:
check with the control application whether a user determined volume of brine is available for transfer to the external storage;
in the event there is a sufficient volume of brine available for transfer of the user determined volume to the external storage, transferring the user determined volume of brine to the external storage; and
in the event there is not a sufficient volume of brine available for transfer of the user determined volume, initiating brine making with the control application.

16. The non-transitory computer-readable storage medium of claim 14, wherein the instructions further cause the computer to cause the controller to initiate a brine transfer by isolating a mixing hopper of the brine making system with the control application, opening a brine valve of the brine making system with the control application, and activating a pump of the brine making system with the control application.

17. The non-transitory computer-readable storage medium of claim 16, wherein the instructions further cause the computer to cause the controller to:
set a user determined volume of brine to transfer with the control application;
select a percentage of brine versus brine additive to be transferred by controlling the brine making system with the control application; and
direct a blend of brine and brine additive with a flow control selection on the control application.

18. The non-transitory computer-readable storage medium of claim 14, wherein the instructions further cause the computer to cause the controller to initiate the brine transfer by:
entering a unique log in via the control application;
providing billing information for a brine dispensing operation via the control application; and
controlling dispensing of brine form the brine dispensing system via the control application, including controlling a volume of brine dispensed and an optional volume of brine additive dispensed.

19. A mobile application for controlling a brine dispensing system of a brine making system, comprising:
providing functionality to control functions of the brine dispensing system including:
connecting remotely to a controller of the brine making system with a control application; and
initiating a brine transfer from brine storage of the brine making system to an external storage with the control application.

20. The mobile application of claim 19, wherein the mobile application provides further functionality for:
setting a user determined volume of brine to transfer with the control application;
selecting a percentage of brine versus brine additive to be transferred by controlling the brine making machine with the control application; and
directing a blend of brine and brine additive with a flow control selection on the control application.

21. The method of claim 1, further comprising monitoring salinity of brine in the brine making system.

22. The method of claim 21, wherein monitoring salinity of brine in the brine making system includes sensing conductivity of brine in the brine making system.

23. The method of claim 1, further comprising supplying data to the controller indicative of at least one of a group including present weather conditions, forecast weather conditions, road conditions, ambient temperature, snow accumulation, humidity, traffic conditions, and condition of brine application equipment, and based on the supplied data, determining a target saturation of brine.
